(19) United States
(12) Patent Application Publication
(10) Pub. No.: US 2003/0210778 A1
(43) Pub. Date: Nov. 13, 2003

(54) Active telephone directory method and apparatus

(75) Inventors: Cary Lee Bates, Rochester, MN (US); Mahdad Majd, Rochester, MN (US); John Matthew Santosuosso, Rochester, MN (US)

Correspondence Address: Grant A. Johnson, IBM Corporation - Dept. 917, 3605 Highway 52 North, Rochester, MN, 55901, US

(73) Assignee: INTERNATIONAL BUSINESS MACHINES CORPORATION, ARMONK, NY

(21) Appl. No.: 10/143,361

(22) Filed: May 9, 2002

(51) Int. Cl. H04M 1/00; H04M 3/00

(52) U.S. Cl. 379/355.02

(57) ABSTRACT

An active telephone directory method and telephone apparatus are provided for automated, flexible and efficient telephone usage. An active telephone directory for predefined telephone numbers is stored. The active telephone directory stores for each predefined telephone number an associated condition and a specified action for the associated condition. Responsive to dialing one predefined telephone number, checking for the associated condition for the dialed predefined telephone number is performed. Responsive to identifying the associated condition, the specified action for the associated condition for the dialed predefined telephone number is performed. The active telephone directory stores historical usage data for each predefined telephone number including a number of calls and total time. When an event to display address entry is identified, then a predefined telephone number for the address entry is displayed with stored usage information.

### FIELD OF THE INVENTION

The present invention relates to an active telephone directory method and telephone apparatus.

### DESCRIPTION OF THE RELATED ART

Some currently available telephone services and telephones have many features and improvements. For example, speech recognition can be used instead of a telephone keypad to dial entries in a personal address book.

However, it is still often difficult or cumbersome and time consuming to satisfactorily complete a call. How often have you called a party to either receive their busy signal or answering machine. With today's surging use of cell phones and pagers, it be would nice to actually get to your party.

A need exists for telephone apparatus that enables automated, flexible and efficient telephone usage.

### SUMMARY OF THE INVENTION

A principal object of the present invention is to provide an active telephone directory method and telephone apparatus. Other important objects of the present invention are to provide such an active telephone directory method and apparatus substantially without negative effect and that overcome many of the disadvantages of prior art arrangements.

In brief, an active telephone directory method and telephone apparatus are provided for automated, flexible and efficient telephone usage. An active telephone directory for predefined telephone numbers is stored. The active telephone directory stores for each predefined telephone number an associated condition and a specified action for the associated condition. Responsive to dialing one predefined telephone number, checking for the associated condition for the dialed predefined telephone number is performed. Responsive to identifying the associated condition, the specified action for the associated condition for the dialed predefined telephone number is performed.

In accordance with features of the invention, active telephone directory stores historical usage data for each predefined telephone number including a number of calls and total time. When an event to display address entry is identified, then a predefined telephone number for the address entry is displayed with stored usage information.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is block diagram illustrating telephone apparatus for implementing active telephone directory methods in accordance with the preferred embodiment;

FIGS. 2A and 2B together provide a flow chart illustrating exemplary steps for implementing active telephone directory methods in accordance with the preferred embodiment;

FIG. 3 is a block diagram illustrating an active telephone directory in accordance with the preferred embodiment; and

FIG. 4 is a block diagram illustrating a computer program product in accordance with the preferred embodiment.

### DETAILED DESCRIPTION OF THE PREFERRED EMBODIMENTS

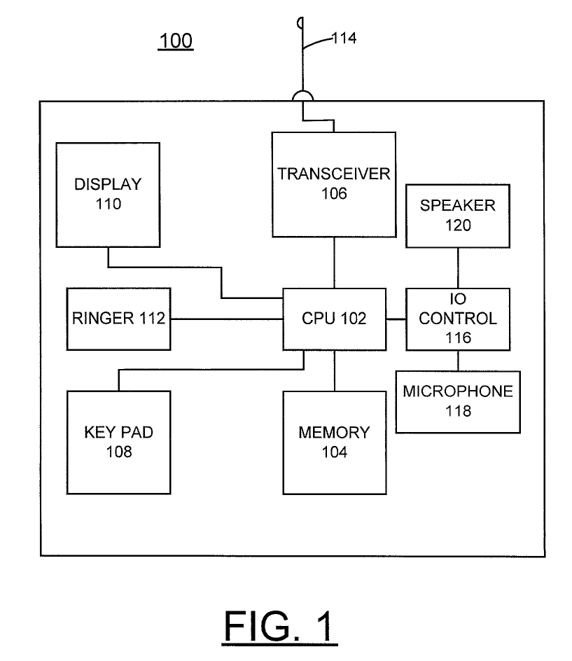

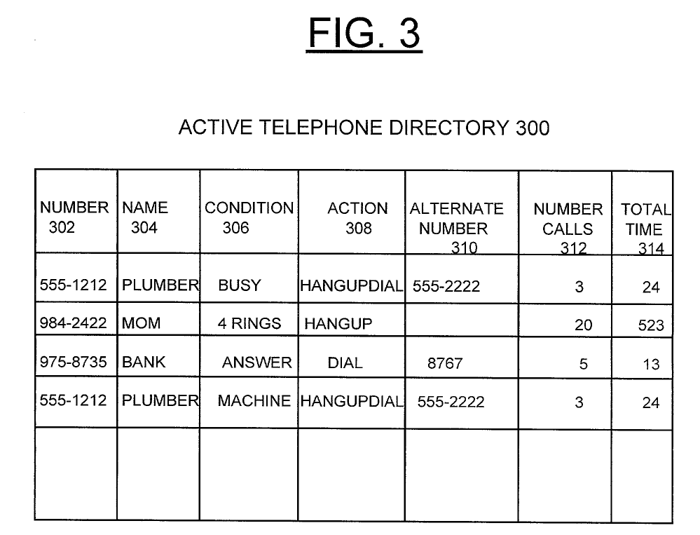

Having reference now to the drawings, in FIG. 1, there is shown telephone apparatus generally designated by the reference character 100 for carrying out active telephone directory methods of the preferred embodiment. As shown in FIG. 1, telephone apparatus 100 includes a central processor unit (CPU) 102. CPU 102 is connected to a memory 104 that stores an active telephone directory 300 as illustrated and described with respect to FIG. 3. CPU 102 is connected to a transceiver 106 that is coupled to an antenna 114. CPU 102 is connected to a keypad 108, a display 110 and a ringer 112. CPU 102 is connected to an input/output (I/O) controller 116 connected to a microphone 118 and a speaker 120.

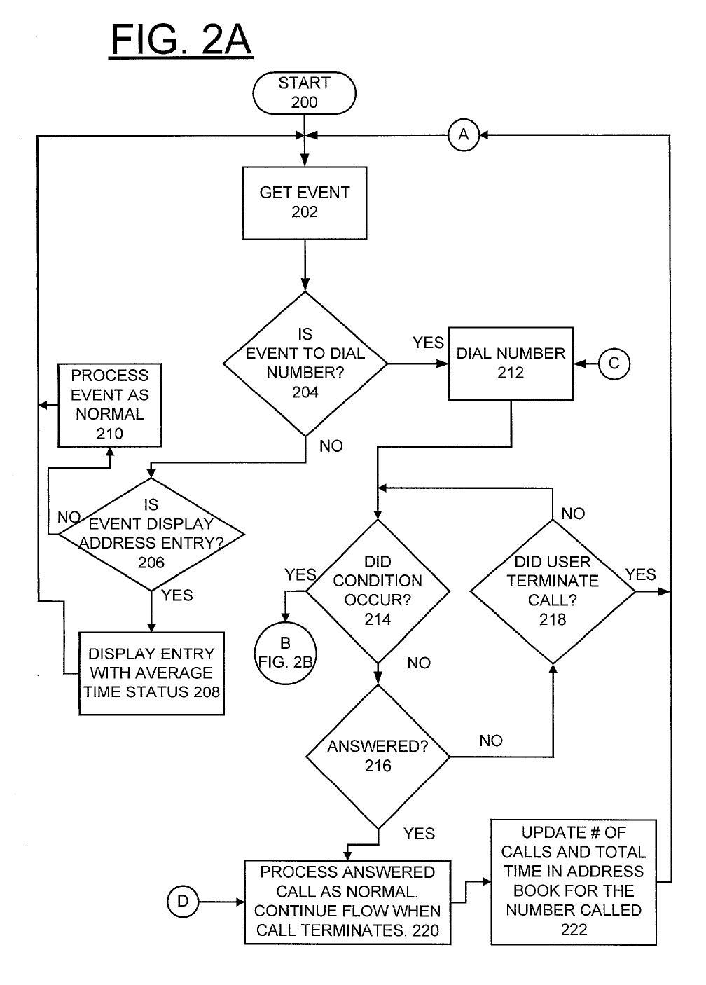

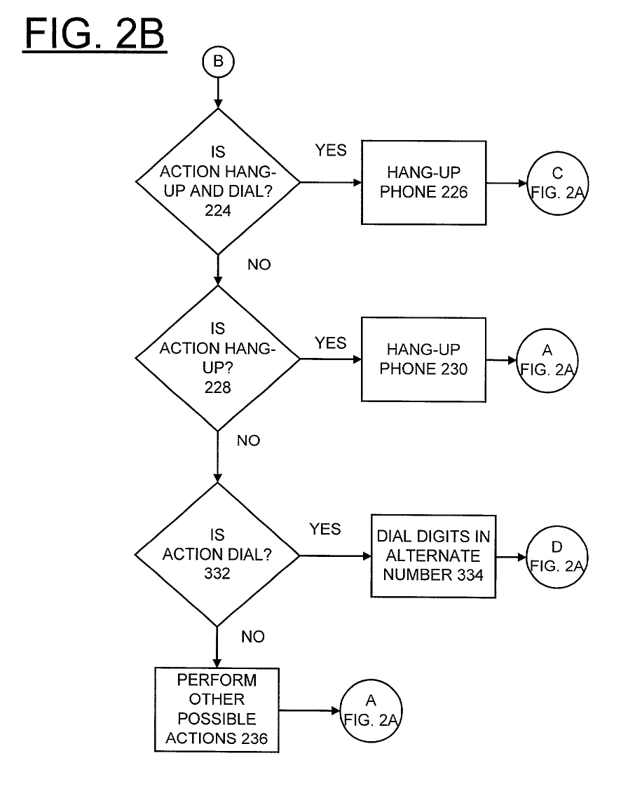

CPU 102 is suitably programmed to execute the flowchart of FIGS. 2A and 2B and to store and maintain the active telephone directory 300 of FIG. 3.

In accordance with features of the preferred embodiment, the localized phone book or directory 300 is used which identifies conditions, and specifies actions for a particular number, the telephone apparatus 100 automatically does the next action upon receiving a condition when a particular number is called.

In accordance with features of the preferred embodiment, the conditions include, for example, receiving a busy signal; a predefined number of rings occurring; an answering machine answering; and a call completed normally. The answering machine answering is known, for example, by knowing how many rings the answering machine for a given number takes and comparing a saved audio clip of the particular answering machine.

In accordance with features of the preferred embodiment, when a number is dialed and a predefined condition occurs an action will be taken. Common actions include, for example, hang-up; hang-up and dial another number; and wait and dial additional digits. Rules which act on conditions can be chained, for instance if a first number is dialed and it has an action associated with it that causes another alternate number to be dialed, then when that alternate number is dialed any conditions that are stored for the alternate number will also have their action performed if the conditions are true.

Optionally when an action specifies that another number be dialed, it can specify that the condition associated with that number be ignored. This would be the default behavior if a number is “circled back to”. Assume, for example, an answering machine is reached for a first home number called, then a cell phone is called and is busy, then the home number called again, and user now leaves message with the home answering machine.

In accordance with features of the preferred embodiment, another option that is added allows statistical collection on phone numbers. Individuals usually have a set of numbers that they normally call and statistics, such as average length of phone calls can be calculated and kept in a database or the active telephone directory 300. This data can be presented as the wait time for a phone connection. Knowing that a user normally calls a set of phone numbers then usage information, such as the average call time can be added to the active telephone directory 300. The predefined telephone number with stored usage information can be displayed or used as a decision point when the telephone number is being considered for dialing.

Referring now to FIGS. 2A and 2B, there are shown exemplary steps for implementing active telephone directory methods in accordance with the preferred embodiment starting at a block 200. An event is obtained as indicated in a block 202. Checking whether the event is dial a telephone number is performed as indicated in a decision block 204. When the event is not dial a telephone number, then checking whether the event is display an address entry is performed as indicated in a decision block 206. If the event is display an address entry, then the entry is displayed with an average time status as indicated in a block 208. Otherwise, if the event is display an address entry, then the event is processed as normal as indicated in a block 210.

When the event is dial a telephone number at decision block 204, then the number is dialed as indicated in a block 212. Checking whether a condition occurred is performed as indicated in a decision block 214. When a condition did not occur, then checking whether the dialed telephone number is answered as indicated in a decision block 216. If the dialed telephone number has not been answered, then checking whether the user has terminated the call is performed as indicated in a decision block 218. If the user has terminated the call, then the sequential steps return to an entry point A to get an event at block 202.

If the user has not terminated the call, then the sequential steps return to decision block 216 for checking whether a condition has occurred. If the dialed telephone number has been answered, then the answered call is processed as normal and the sequential flow continues when the call terminates as indicated in a block 220. Then the number of call and total time are updated in the address book or active telephone directory 300 of FIG. 3 for the number called as indicated in a block 222. When a condition occurred at decision block 214, then the sequential steps continue following entry point B in FIG. 2B.

Referring to FIG. 2B, a predefined condition now has occurred and an action is taken as shown. Checking whether the action is hang-up and dial is performed as indicated in a decision block 224. If the action is hang-up and dial, then the phone hang-up is performed as indicated in a block 226. Then the sequential steps return to an entry point C in FIG. 2A at block 212 to dial a specified number for the hang-up and dial action and continue.

Otherwise checking whether the action is hang-up is performed as indicated in a decision block 228. If the action is hang-up, then the phone hang-up is performed as indicated in a block 230. Then the sequential steps return to entry point A in FIG. 2A to get an event at block 202 and continue.

Otherwise checking whether the action is dial is performed as indicated in a decision block 232. If the action is dial, then the digits of the alternate number are dialed as indicated in a block 234. Then the sequential steps return to an entry point D in FIG. 2A to process answered call as normal at block 220 and continue. Otherwise other possible actions are performed as indicated in a block 236.

Referring to FIG. 3, there is shown the active telephone directory 300 of the preferred embodiment. Active telephone directory 300 includes a plurality of entries, each including, for example, a first telephone number 302, a name 204, a condition 306, an action 308, an alternate number 310, and historical data including a number of calls 312 and total time 314.

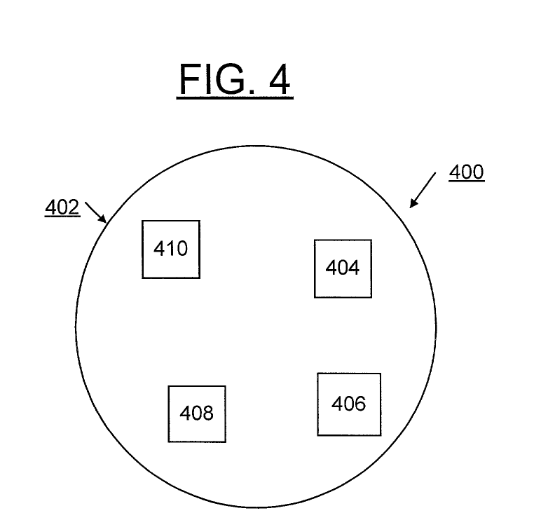

Referring now to FIG. 4, an article of manufacture or a computer program product 400 of the invention is illustrated. The computer program product 400 includes a recording medium 402, such as, a floppy disk, a high capacity read only memory in the form of an optically read compact disk or CD-ROM, a tape, a transmission type media such as a digital or analog communications link, or a similar computer program product. Recording medium 402 stores program means 404, 406, 408, 410 on the medium 402 for carrying out the active telephone directory methods of the preferred embodiment in the telephone apparatus 100 of FIG. 1.

A sequence of program instructions or a logical assembly of one or more interrelated modules defined by the recorded program means 404, 406, 408, 410, direct the telephone apparatus 100 for implementing the active telephone directory methods of the preferred embodiment.

While the present invention has been described with reference to the details of the embodiments of the invention shown in the drawing, these details are not intended to limit the scope of the invention as claimed in the appended claims.

What is claimed is:

1. An active telephone directory method comprising the steps of:
storing an active telephone directory for predefined telephone numbers; said active telephone directory storing for each predefined telephone number an associated condition and a specified action for said associated condition;
dialing one said predefined telephone number;
responsive to dialing one said predefined telephone number, checking to identify said associated condition for the dialed predefined telephone number; and
responsive to identifying said associated condition, performing said specified action for said associated condition for the dialed predefined telephone number.

2. An active telephone directory method as recited in claim 1 wherein the step of checking to identify said associated condition for the dialed predefined telephone number includes the step of checking to identify receiving a busy signal.

3. An active telephone directory method as recited in claim 1 wherein the step of checking to identify said associated condition for the dialed predefined telephone number includes the step of checking to identify a predetermined number of rings occurring.

4. An active telephone directory method as recited in claim 1 wherein the step of checking to identify said associated condition for the dialed predefined telephone number includes the step of checking to identify an answering machine answering.

5. An active telephone directory method as recited in claim 1 wherein the step of checking to identify said associated condition for the dialed predefined telephone number includes the step of checking to identify a call completed normally.

6. An active telephone directory method as recited in claim 1 wherein the step of performing said specified action for said associated condition for the dialed predefined telephone number includes the step of performing a phone hang-up.

7. An active telephone directory method as recited in claim 1 wherein the step of performing said specified action for said associated condition for the dialed predefined telephone number includes the step of performing a phone hang-up and dialing an alternate telephone number.

8. An active telephone directory method as recited in claim 1 wherein the step of performing said specified action for said associated condition for the dialed predefined telephone number includes the step of dialing an alternate telephone number.

9. An active telephone directory method as recited in claim 1 includes the step of processing an answered call for the dialed predefined telephone number.

10. An active telephone directory method as recited in claim 9 includes the step of identifying a termination of the answered call, and updating a number of calls and total time value for the dialed predefined telephone number of the answered call in said active telephone directory.

11. An active telephone directory method as recited in claim 1 includes the step storing usage information for each predefined telephone number.

12. An active telephone directory method as recited in claim 11 includes the step of identifying an event to display address entry, and displaying a predefined telephone number for the address entry with said stored usage information.

13. Telephone apparatus for automated telephone usage comprising:
a memory for storing an active telephone directory for predefined telephone numbers; said active telephone directory storing for each predefined telephone number an associated condition and a specified action for said associated condition;
a central processor unit coupled to said memory; said central processor unit utilizing said active telephone directory for performing the steps of:
dialing one said predefined telephone number;
responsive to dialing one said predefined telephone number, checking to identify said associated condition for the dialed predefined telephone number; and
responsive to identifying said associated condition, performing said specified action for said associated condition for the dialed predefined telephone number.

14. Telephone apparatus for automated telephone usage as recited in claim 13 wherein said active telephone directory storing for each predefined telephone number said associated condition and said specified action for said associated condition includes storing said associated condition including at least one of receiving a busy signal; a predefined number of rings occurring; an answering machine answering; and a call completed normally.

15. Telephone apparatus for automated telephone usage as recited in claim 14 includes storing said specified action for said associated condition including at least one of a hang-up and dial action; a hang-up action; and a dial action.

16. Telephone apparatus for automated telephone usage as recited in claim 15 wherein said hang-up and dial action includes an alternate telephone number for dialing responsive to performing said phone hang-up.

17. Telephone apparatus for automated telephone usage as recited in claim 15 wherein said dial action includes an alternate telephone number for dialing responsive to a call completed normally.

18. Telephone apparatus for automated telephone usage as recited in claim 13 wherein said hang-up action is performed responsive to said associated condition of said predefined number of rings occurring.

19. Telephone apparatus for automated telephone usage as recited in claim 13 wherein said active telephone directory storing usage information for each predefined telephone number.

20. Telephone apparatus for automated telephone usage as recited in claim 19 wherein said central processor unit utilizing said active telephone directory for performing the steps of identifying an event to display address entry, and displaying a predefined telephone number for the address entry with said stored usage information.
